(19) United States
(12) Patent Application Publication
(10) Pub. No.: US 2024/0264824 A1
(43) Pub. Date: Aug. 8, 2024

(54) METHOD OF UPDATING FIRMWARE OF COMPUTER

(71) Applicant: Mitac Computing Technology Corporation, Taoyuan City (TW)

(72) Inventor: Cheng-Wei SUN, Taoyuan City (TW)

(73) Assignee: Mitac Computing Technology Corporation, Taoyuan City (TW)

(21) Appl. No.: 18/424,241

(22) Filed: Jan. 26, 2024

(30) Foreign Application Priority Data
Feb. 3, 2023 (TW) 112103837

(51) Int. Cl. G06F 8/654

(52) U.S. Cl. CPC G06F 8/654

(57) ABSTRACT

A method of updating a firmware of a computer including a motherboard that has a BMC and a first CPLD, and a backplane that has a second CPLD having a flash memory. The method including steps of: the first CPLD changing a logical value of a signal when the first CPLD determines that a power of the computer is in a desired range; the BMC receiving the signal, and being initiated once the logical value of the signal has been changed; when the BMC is to update a firmware of the second CPLD, the BMC changing a logical value of a register of the first CPLD; and when the first CPLD determines that the logical value of the register has been changed, the first CPLD decoding and verifying a firmware code that is received from the BMC, and updating the firmware code thus decoded and verified to the flash memory.

### CROSS-REFERENCE TO RELATED APPLICATION

This application claims priority to Taiwanese Invention Patent Application No. 11/210,3837, filed on Feb. 3, 2023.

### FIELD

The disclosure relates to an updating method, and more particularly to a method of updating a firmware of a server.

### BACKGROUND

A conventional server, whether acting as a compute node, a storage node, or a network node, usually includes a motherboard, a backplane that is electrically connected to the motherboard, a complex programmable logic device (CPLD) that is disposed on the backplane, and a basic input/output system (BIOS) and a baseboard management controller (BMC) that are both disposed on the motherboard. The CPLD on the backplane includes a flash memory for storing a firmware that is to be executed by the CPLD.

When the firmware of the CPLD on the backplane needs to be updated, a conventional method is to update the firmware using the BMC. After updating the firmware that is stored in the flash memory of the CPLD, the BMC notifies the BIOS to control a power unit that is disposed on the motherboard to restart, thus cutting off and then turning on power that is provided by the power unit to both the motherboard and the backplane, thereby completing the update of the firmware. That is, the system is rebooted when updating the CPLD firmware.

### SUMMARY

An object of the disclosure is to provide an alternative method of updating a firmware of a computer that is more flexible.

According to the disclosure, a method of updating a firmware of a computer is provided. The computer includes a motherboard, a backplane, a baseboard management controller (BMC), a first complex programmable logic device (CPLD), a second CPLD, and a basic input/output system (BIOS). The backplane is electrically connected to the motherboard. The BMC, the first CPLD, and the BIOS are disposed on the motherboard. The second CPLD is disposed on the backplane and has a second-CPLD flash memory. The method includes steps of: A) the first CPLD being initiated after the computer is connected to a power source, and changing a logical value of a power-on reset signal when the first CPLD determines that a standby power of the computer is in a desired range; B) the BMC and the BIOS receiving the power-on reset signal, and being initiated once the logical value of the power-on reset signal has been changed; C) after a power-on button of the computer is being pressed, once the BMC determines that a central processing unit (CPU) of the computer is initiated, and that the BMC is to update a firmware of the second CPLD, the BMC changing a logical value of a first bit of a register of the first CPLD; and D) when the first CPLD determines that the logical value of the first bit of the register has been changed, the first CPLD decoding a first firmware code that is received from the BMC, verifying the first firmware code thus decoded, and updating the first firmware code thus decoded and verified to the second-CPLD flash memory.

According to the disclosure, a computer includes a motherboard, a backplane, a first CPLD, a second CPLD, and a BMC. The backplane is electrically connected to the motherboard. The second CPLD is disposed on the backplane and has a second-CPLD flash memory. The first CPLD and the BMC are disposed on the motherboard. The first CPLD has a register, and is configured to be initiated after the computer is connected to a power source, and to change a logical value of a power-on reset signal when determining that a standby power of the computer is in a desired range. The BMC is configured to receive the power-on reset signal, and to be initiated once the logical value of the power-on reset signal has been changed. The BMC is further configured to, after a power-on button of the computer has been pressed, once determining that a central processing unit (CPU) of the computer is initiated, and that the BMC is to update a firmware of the second CPLD, change a logical value of the register of the first CPLD. The first CPLD is further configured to, when determining that the logical value of the register has been changed, decode a firmware code that is received from the BMC, verify the firmware code thus decoded, and update the firmware code thus decoded and verified to the second-CPLD flash memory.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computer according to an embodiment of the disclosure.

FIG. 2 is a flow chart illustrating a method of updating a firmware of a computer according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

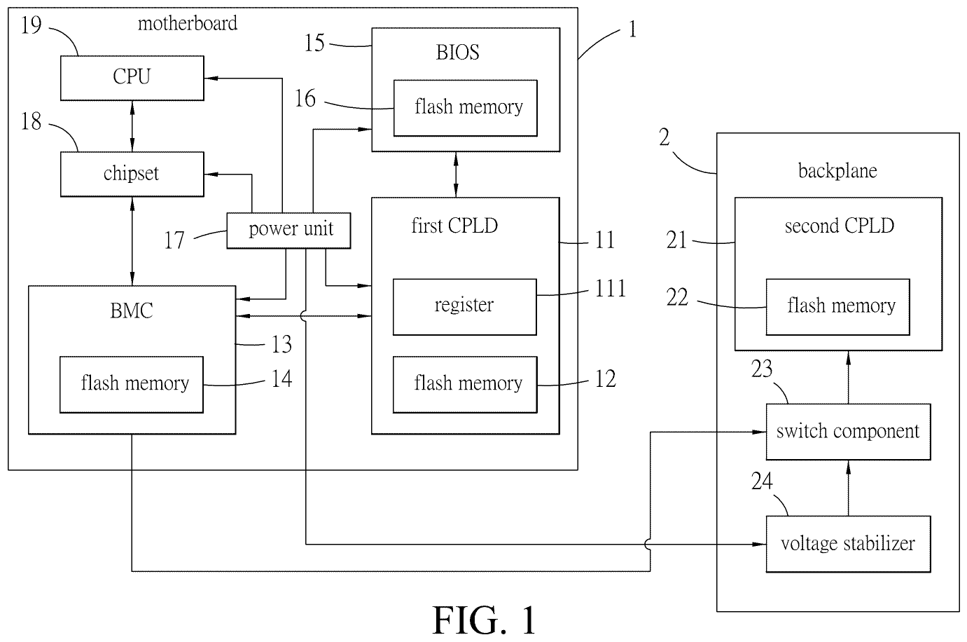

Referring to FIG. 1, a computer for implementing a method of updating a firmware of the computer according to an embodiment of the disclosure is illustrated. In this embodiment, the computer is a server and includes a motherboard 1 and a backplane 2 that is electrically connected to the motherboard 1. The motherboard 1 includes a baseboard management controller (BMC) 13, a first complex programmable logic device (CPLD) 11, a central processing unit (CPU) 19, a chipset 18 (e.g., platform controller hub (PCH)), a basic input/output system (BIOS) 15, and a power unit 17. The backplane 2 includes a second CPLD 21, a voltage regulator 24, and a switch component 23 electrically connected between the second CPLD 21 and the voltage regulator 24. The switch component 23 may be a relay. The power unit 17 is electrically connected to the first CPLD 11, the BMC 13, the BIOS 15, the chipset 18, the CPU 19, and the voltage regulator 24, and may be implemented as a power supply unit that is configured to convert an alternating current (AC) power received from a wall socket to a direct current (DC) power for the computer to operate with. The BIOS 15 may be in a form of a chip that includes a BIOS firmware.

In this embodiment, the first CPLD 11 acts as a root of trust (RoT) chip and supports a platform firmware resilience (PFR) function that is established by Intel Corporation. The first CPLD 11 includes a flash memory 12 (referred to as first-CPLD flash memory hereinafter) that stores a firmware of the first CPLD 11, the second CPLD 21 includes a flash memory 22 (referred to as second-CPLD flash memory hereinafter) that stores a firmware of the second CPLD 21, the BMC 13 includes a flash memory 14 (referred to as BMC flash memory hereinafter) that stores a firmware of the BMC 13, and the BIOS 15 includes a flash memory 16 (referred to as BIOS flash memory hereinafter) that stores a firmware of the BIOS 15. The second-CPLD flash memory 22, the first-CPLD flash memory 12, the BMC flash memory 14, and the BIOS flash memory 16 may be disposed inside or outside of the second CPLD 21, the first CPLD 11, the BMC 13, and the BIOS 15 respectively. In some embodiments, the computer may further include one or more additional motherboards that have similar functions to the motherboard 1, and similar components to the motherboard 1 that are disposed on the additional motherboard(s), and/or one or more additional backplanes that have similar functions to the backplane 2. In some embodiments, the chipset 18 and the CPU 19 may be integrated into a system on a chip (SoC).

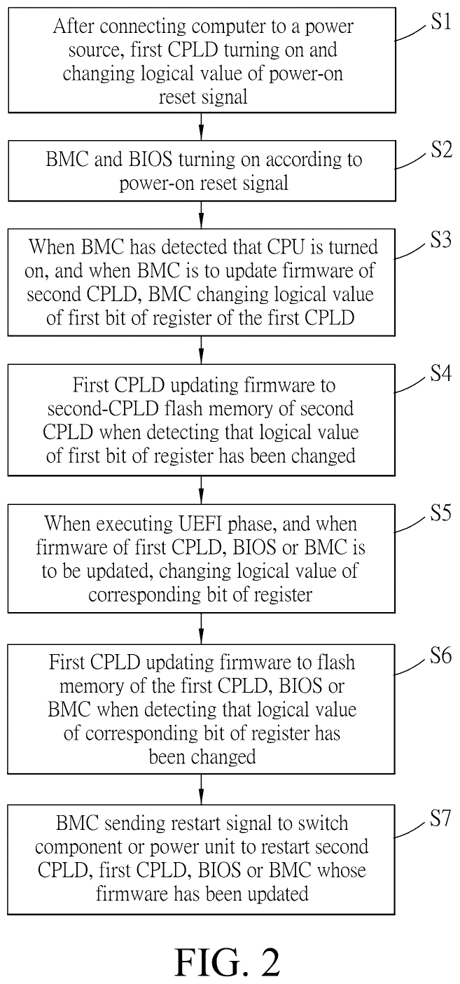

Further referring to FIG. 2, a flow of the method of updating the firmware of the computer includes steps S1 to S7.

In step S1, after the computer is connected to a power source (i.e., the power unit 17 is electrically connected to the wall socket to obtain electricity), the power unit 17 outputs a first standby power and a second standby power, and the first CPLD 11 is initiated by the first standby power. When the first CPLD 11 determines that the second standby power provided by the power unit 17 is normal (e.g. a voltage of the second standby power provided by the power unit 17 is in a desired range), the first CPLD 11 changes a logical value of a power-on reset signal (e.g., from zero to one), and the flow proceeds to step S2. In some embodiments, the first CPLD 11 includes a voltage detection circuit and determines the voltage of the second standby power directly. In some embodiments, the first CPLD 11 determines the voltage of the second standby power by receiving a voltage detection signal that is generated by an external voltage detection circuit.

In step S2, the BMC 13 and the BIOS 15 receive the power-on reset signal, and are initiated by the second standby power once the logical value of the power-on reset signal has been changed (e.g., from zero to one). In this embodiment, the change of the logical value of the power-on reset signal from zero to one indicates that the second standby power outputted by the power unit 17 is in the desired range for initiating the BMC 13 and the BIOS 15, and the flow proceeds to step S3.

In step S3, the power unit 17 outputs a main power after a power-on button of the computer has been pressed, and the CPU 19 operates with the main power. The voltage stabilizer 24 transforms and stabilizes a voltage of the main power to a backplane power for the second CPLD 21 to operate at. Once the BMC 13 determines that the CPU 19 is initiated according to a first predetermined signal that is received from the CPU 19 directly or indirectly (e.g., received through the chipset 18), and that the BMC 13 is to update the firmware of the second CPLD 21, the BMC 13 changes a logical value of a first bit of a register 111 of the first CPLD 11 (e.g., from zero to one) via a first inter-integrated circuit (I2C) interface, and sends a first firmware code that is for updating the firmware of the second CPLD 21 and that is received from the chipset 18 to the first CPLD 11 via the first I2C interface. The flow then proceeds to step S4.

The register 111 may be a mailbox register. The main power may include multiple different DC voltages, such as 1 volt, 1.2 volts, 1.5 volts, etc. In this embodiment, the BMC 13 may determine that the firmware of the second CPLD 21 is to be updated according to an update command that is received from a user.

In step S4, when the first CPLD 11 determines that the logical value of the first bit of the register 111 has been changed (e.g., from zero to one), the first CPLD 11 decodes the first firmware code that is received from the BMC 13, verifies the first firmware code thus decoded, and then updates the first firmware code thus decoded and verified to the second-CPLD flash memory 22 via a second I2C interface. That is to say, the first CPLD 11 decodes data (including the first firmware code) that is received form the BMC 13, and verifies the first firmware code thus decoded to make sure that the first firmware code is the code for updating the firmware of the second CPLD 21. After the first CPLD 11 updates the firmware of the second CPLD 21 (i.e., updating the first firmware code to the second-CPLD flash memory 22), the first CPLD 11 changes the logical value of the first bit of the register 111 again (e.g., changing from one back to zero), and the flow proceeds to step S5. When the first CPLD 11 determines that the logical value of the first bit of the register 111 has not been changed at the beginning of step S4, the flow proceeds to step S5 directly.

In step S5, after the CPU 19 executes an ACM/VCM phase (ACM-or-VCM phase, where “ACM” stands for “authenticated code module”, and “VCM” stands for “vendor code module”) and when the CPU 19 is executing a unified extensible firmware interface (UEFI) phase, a firmware of the first CPLD 11, a firmware of the BIOS 15, and a firmware of the BMC 13 may be updated. The ACM/VCM phase is a security verification phase that is related to the BIOS 15 and that is established by Intel Corporation. The CPU 19 is configured to execute contents of the BIOS 15 only after the BIOS 15 has passed the security verification phase. The UEFI phase refers to the CPU 19 having performed a boot process and executed a UEFI shell after the computer is booted up, meaning that the boot process has been completed. It should be noted that the BMC 13 is configured to determine whether the CPU 19 has executed or is executing the ACM/VCM phase and the UEFI phase according to a second predetermined signal that is received from the CPU 19.

To describe in further detail, in step S5, when the BMC 13 is to update the firmware of the first CPLD 11, the BMC 13 changes a logical value of a second bit of the register 111 (e.g., from zero to one) via the first I2C interface, and sends a second firmware code that is for updating the firmware of the first CPLD 11 and that is received from the chipset 18 to the first CPLD 11 via the first I2C interface; when the chipset 18 is to update the firmware of the BIOS 15, the chipset 18 changes a logical value of a third bit of the register 111 (e.g., from zero to one) via a third I2C interface, and the chipset 18 sends a third firmware code that is for updating the firmware of the BIOS 15 to the first CPLD 11 via the third I2C interface; when the BMC 13 is to update the firmware of the BMC 13, the BMC 13 changes a logical value of a fourth bit of the register 111 (e.g., from zero to one) via the first I2C interface, and sends a fourth firmware code that is for updating the firmware of the BMC 13 and that is received from the chipset 18 to the first CPLD 11 via the first I2C interface. The flow then proceeds to step S6. In this embodiment, the BMC 13 or the chipset 18 may determine whether the firmware of the first CPLD 11, the firmware of the BMC 13, or the firmware of the BIOS 15 is to be updated according to the update command that is received from the user.

In step S6, when the first CPLD 11 determines that the logical value of the second bit of the register 111 has been changed (e.g., from zero to one), the first CPLD 11 decodes the second firmware code that is received from the BMC 13, verifies the second firmware code thus decoded, updates the second firmware code thus decoded and verified to the first-CPLD flash memory 12, and changes the logical value of the second bit of the register 111 again (e.g., changing from one back to zero); when the first CPLD 11 determines that the logical value of the third bit of the register 111 has been changed (e.g., from zero to one), the first CPLD 11 decodes the third firmware code that is received from the chipset 18, verifies the third firmware code thus decoded, updates the third firmware code thus decoded and verified to the BIOS flash memory 16, and changes the logical value of the third bit of the register 111 again (e.g., changing from one back to zero); when the first CPLD 11 determines that the logical value of the fourth bit of the register 111 has been changed (e.g., from zero to one), the first CPLD 11 decodes the fourth firmware code that is received from the BMC 13, verifies the fourth firmware code thus decoded, updates the fourth firmware code thus decoded and verified to the BMC flash memory 14, and changes the logical value of the fourth bit of the register 111 again (e.g., changing from one back to zero). The flow then proceeds to step S7.

When the first CPLD 11 determines that the logical value of the second bit, the third bit, and the fourth bit of the register 111 have not been changed at the beginning of step S6, and that the logical value of the first bit of the register 111 has not been changed at the beginning of step S4, the flow of the method ends; otherwise, the flow proceeds to step S7.

In step S7, when the BMC 13 determines that the logical value of the first bit of the register 111 conforms with a first predetermined condition indicating that the firmware of the second CPLD 21 has been updated (e.g., the logical value of the first bit of the register 111 has been changed from one to zero), the BMC 13 sends a first restart signal to the switch component 23 for controlling the switch component 23 to switch from on to off and then to on again, thus switching the backplane power that is provided by the voltage stabilizer 24 to the second CPLD 21 through the switch component 23 off and then on, thereby restarting the second CPLD 21.

When the BMC 13 determines that the logical value of the second bit of the register 111 conforms with a second predetermined condition indicating that the firmware of the first CPLD 21 has been updated (e.g., the logical value of the second bit of the register 111 has been changed from one to zero), the BMC 13 sends a second restart signal to the power unit 17, thus switching the main power that is provided by the power unit 17 to the first CPLD 11 off and then on, thereby restarting the first CPLD 11.

When the BMC 13 determines that the logical value of the third bit of the register 111 conforms with a third predetermined condition indicating that the firmware of the BIOS 15 has been updated (e.g., the logical value of the third bit of the register 111 has been changed from one to zero), the BMC 13 sends a third restart signal to the power unit 17, thus switching the main power that is provided by the power unit 17 to the BIOS 15 off and then on, thereby restarting the BIOS 15.

When the BMC 13 determines that the logical value of the fourth bit of the register 111 conforms with a fourth predetermined condition indicating that the firmware of the BMC 13 has been updated (e.g., the logical value of the fourth bit of the register 111 has been changed from one to zero), the BMC 13 sends a fourth restart signal to the power unit 17, thus switching the main power that is provided by the power unit 17 to the BMC 13 off and then on, thereby restarting the BMC 13.

In some embodiments, in step S7, when the BMC 13 determines that the logical value of the first bit of the register 111 conforms with the first predetermined condition, the BMC 13 changes a logical value of a fifth bit of the register 111 (e.g., from zero to one). And when the first CPLD 11 determines that the logical value of the fifth bit of the register 111 has been changed, the first CPLD 11 sends the first restart signal to the switch component 23, thereby restarting the second CPLD 21.

When the BMC 13 determines that the logical value of the second bit of the register 111 conforms with the second predetermined condition, the BMC 13 changes a logical value of a sixth bit of the register 111 (e.g., from zero to one). And when the first CPLD 11 determines that the logical value of the sixth bit of the register 111 has been changed, the first CPLD 11 sends the second restart signal to the power unit 17, thereby restarting the first CPLD 11.

When the BMC 13 determines that the logical value of the third bit of the register 111 conforms with the third predetermined condition, the BMC 13 changes a logical value of a seventh bit of the register 111 (e.g., from zero to one). And when the first CPLD 11 determines that the logical value of the seventh bit of the register 111 has been changed, the first CPLD 11 sends the third restart signal to the power unit 17, thereby restarting the BIOS 15.

When the BMC 13 determines that the logical value of the fourth bit of the register 111 conforms with the fourth predetermined condition, the BMC 13 changes a logical value of an eighth bit of the register 111 (e.g., from zero to one). And when the first CPLD 11 determines that the logical value of the eighth bit of the register 111 has been changed, the first CPLD 11 sends the fourth restart signal to the power unit 17, thereby restarting the BMC 13.

It should be noted that sub-steps in step S7 may be performed simultaneously or without specific order.

In summary, after the first CPLD 11, the BMC 13 and the BIOS 15, and the CPU 19 of the motherboard 1 are being initiated in sequence, when the first CPLD 11 determines that the logical value of one of the first bit, the second bit, the third bit, and the fourth bit of the register 111 has been changed by the BMC 13, the first CPLD 11 updates one of the firmware of the second CPLD 21, the firmware of the first CPLD 11, the firmware of the BIOS 15, and the firmware of the BMC 13 according to which of said one of the first bit, the second bit, the third bit, and the fourth bit of the register 111 has been changed. Furthermore, since the BMC 13 is configured to determine whether the CPU 19 has executed or is executing the ACM/VCM phase and the UEFI phase so as to determine whether to update the firmware of the computer, a timing of the BMC 13 updating the firmware of the second CPLD 21 is before the ACM/VCM phase, and a timing of the BMC 13 updating the firmware of the first CPLD 11, the firmware of the BIOS 15, and/or the firmware of the BMC 13 is after the ACM/VCM phase. As such, there may be an improved connection between the ACM/VCM phase of the CPU 19 and the updating of the firmware of the computer in terms of chronological order.

Regardless of whether the computer includes a single or multiple motherboards, and a single or multiple backplanes, the method is able to update the firmware of the second CPLD 21 that is on any one of the backplanes, and only requires restarting the second CPLD 21 that is on said one of the backplanes to complete the update process, without the need to restart other components that are on the mainboards and other backplanes. In other words, the method of updating the firmware of the computer provided in the disclosure only requires rebooting the second CPLD 21 that is on the backplane 2 and not the other components on the mainboard 1, other backplanes and mainboards, and thus avoids interrupting operation of the other components.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of updating a firmware of a computer, the computer including a motherboard, a backplane being electrically connected to the motherboard, a baseboard management controller (BMC), a first complex programmable logic device (CPLD), a second CPLD, and a basic input/output system (BIOS), the BMC, the first CPLD and the BIOS being disposed on the motherboard, the second CPLD being disposed on the backplane and having a second-CPLD flash memory, the method comprising steps of:
A) the first CPLD being initiated after the computer is connected to a power source, and changing a logical value of a power-on reset signal when the first CPLD determines that a standby power of the computer is in a desired range;
B) the BMC and the BIOS receiving the power-on reset signal, and being initiated once the logical value of the power-on reset signal has been changed;
C) after a power-on button of the computer has been pressed, once the BMC determines that a central processing unit (CPU) of the computer is initiated, and that the BMC is to update a firmware of the second CPLD, the BMC changing a logical value of a first bit of a register of the first CPLD; and
D) when the first CPLD determines that the logical value of the first bit of the register has been changed, the first CPLD decoding a first firmware code that is received from the BMC, verifying the first firmware code thus decoded, and updating the first firmware code thus decoded and verified to the second-CPLD flash memory.

2. The method as claimed in claim 1, wherein in step D), the first CPLD updates the first firmware code to the second-CPLD flash memory before the CPU starts executing one of an authenticated code module (ACM) phase and a vendor code module (VCM) phase.

3. The method as claimed in claim 2, wherein
step D) further includes the first CPLD changing the logical value of the first bit of the register again after updating the first firmware code thus decoded and verified to the second-CPLD flash memory.

4. The method as claimed in claim 3, the computer further including a voltage stabilizer and a switch component that are disposed on the backplane, the method further comprising, after step D), a step of:
E) when the BMC determines that a change of the logical value of the first bit of the register conforms with a predetermined condition, the BMC sending a restart signal to the switch component for controlling the switch component to switch from on to off and then to on again, thus switching a backplane power that is provided by the voltage stabilizer to the second CPLD through the switch component off and then on,
wherein the predetermined condition indicates that the firmware of the second CPLD has been updated.

5. The method as claimed in claim 3, the computer further including a voltage stabilizer and a switch component that are disposed on the backplane, the method further comprising, after step D), steps of:
E) when the BMC determines that a change of the logical value of the first bit of the register conforms with a predetermined condition, the BMC changing a logical value of a second bit of the register; and
F) when the first CPLD determines that the logical value of the second bit of the register has been changed, the first CPLD sending a restart signal to the switch component for controlling the switch component to switch from on to off and then to on again, thus switching a backplane power that is provided by the voltage stabilizer to the second CPLD through the switch component off and then on,
wherein the predetermined condition indicates that the firmware of the second CPLD has been updated.

6. The method as claimed in claim 1, the first CPLD including a first-CPLD flash memory, the method further comprising steps of:
E) after the CPU executes one of an authenticated code module (ACM) phase and a vendor code module (VCM) phase and when the CPU is executing a unified extensible firmware interface (UEFI) phase, when the BMC is to update a firmware of the first CPLD, the BMC changing a logical value of a second bit of the register, wherein the BMC determines whether the CPU 19 has executed one of the ACM phase and the VCM phase and is executing the UEFI phase according to a predetermined signal that is received from the CPU; and
F) when the first CPLD determines that the logical value of the second bit of the register has been changed, the first CPLD decoding a second firmware code that is received from the BMC, verifying the second firmware code thus decoded, and updating the second firmware code thus decoded and verified to the first-CPLD flash memory.

7. The method as claimed in claim 6, wherein
step F) further includes the first CPLD changing the logical value of the second bit of the register again after updating the second firmware code thus decoded and verified to the first-CPLD flash memory.

8. The method as claimed in claim 7, the motherboard further including a power unit that is electrically connected to the first CPLD, the method further comprising, after step F), a step of:
G) when the BMC determines that a change of the logical value of the second bit of the register conforms with a predetermined condition, the BMC sending a restart signal to the power unit, thus switching a power that is provided by the power unit to the first CPLD off and then on;
wherein the predetermined condition indicates that the firmware of the first CPLD has been updated.

9. The method as claimed in claim 7, the motherboard further including a power unit that is electrically connected to the first CPLD, the method further comprising, after step F), steps of:
G) when the BMC determines that a change of the logical value of the second bit of the register conforms with a predetermined condition, the BMC changing a logical value of a third bit of the register; and
H) when the first CPLD determines that the logical value of the third bit of the register has been changed, the first CPLD sending a restart signal to the power unit, thus switching a power that is provided by the power unit to the first CPLD off and then on;
wherein the predetermined condition indicates that the firmware of the first CPLD has been updated.

10. The method as claimed in claim 1, the computer further including a chipset, and the BIOS including a BIOS flash memory, the method further comprising steps of:
E) after the CPU executes one of an authenticated code module (ACM) phase and a vendor code module (VCM) phase and when the CPU is executing a unified extensible firmware interface (UEFI) phase, when the chipset is to update a firmware of the BIOS, the chipset changing a logical value of a second bit of the register, wherein the BMC determines whether the CPU 19 has executed one of the ACM phase and the VCM phase and is executing the UEFI phase according to a predetermined signal that is received from the CPU; and
F) when the first CPLD determines that the logical value of the second bit of the register has been changed, the first CPLD decoding a second firmware code that is received from the chipset, verifying the second firmware code thus decoded, and updating the second firmware code thus decoded and verified to the BIOS flash memory.

11. The method as claimed in claim 10, wherein
step F) further includes the first CPLD changing the logical value of the second bit of the register again after updating the second firmware code thus decoded and verified to the BIOS flash memory.

12. The method as claimed in claim 11, the motherboard further including a power unit that is electrically connected to the BIOS, the method further comprising, after step F), a step of:
G) when the BMC determines that a change of the logical value of the second bit of the register conforms with a predetermined condition, the BMC sending a restart signal to the power unit, thus switching a power that is provided by the power unit to the BIOS off and then on;
wherein the predetermined condition indicates that the firmware of the BIOS has been updated.

13. The method as claimed in claim 11, the motherboard further including a power unit that is electrically connected to the BIOS, the method further comprising, after step F), steps of:
G) when the BMC determines that a change of the logical value of the second bit of the register conforms with a predetermined condition, the BMC changing a logical value of a third bit of the register; and
H) when the first CPLD determines that the logical value of the third bit of the register has been changed, the first CPLD sending a restart signal to the power unit, thus switching a power that is provided by the power unit to the BIOS off and then on;
wherein the predetermined condition indicates that the firmware of the BIOS has been updated.

14. The method as claimed in claim 1, the BMC including a BMC flash memory, the method further comprising steps of:
E) after the CPU executes one of an authenticated code module (ACM) phase and a vendor code module (VCM) phase and when the CPU is executing a unified extensible firmware interface (UEFI) phase, when the BMC is to update a firmware of the BMC, the BMC changing a logical value of a second bit of the register, wherein the BMC determines whether the CPU 19 has executed one of the ACM phase and the VCM phase and is executing the UEFI phase according to a predetermined signal that is received from the CPU; and
F) when the first CPLD determines that the logical value of the second bit of the register has been changed, the first CPLD decoding a second firmware code that is received from the BMC, verifying the second firmware code thus decoded, and updating the second firmware code thus decoded and verified to the BMC flash memory.

15. The method as claimed in claim 14, wherein
step F) further includes the first CPLD changing the logical value of the second bit of the register again after updating the second firmware code thus decoded and verified to the BMC flash memory.

16. The method as claimed in claim 15, the motherboard further including a power unit that is electrically connected to the BMC, the method further comprising, after step F), a step of:
G) when the BMC determines that a change of the logical value of the second bit of the register conforms with a predetermined condition, the BMC sending a restart signal to the power unit, thus switching a power that is provided by the power unit to the BMC off and then on;
wherein the predetermined condition indicates that the firmware of the BMC has been updated.

17. The method as claimed in claim 15, the motherboard further including a power unit that is electrically connected to the BMC, the method further comprising, after step F), steps of:
G) when the BMC determines that a change of the logical value of the second bit of the register conforms with a predetermined condition, the BMC changing a logical value of a third bit of the register; and
H) when the first CPLD determines that the logical value of the third bit of the register has been changed, the first CPLD sending a restart signal to the power unit, thus switching a power that is provided by the power unit to the BMC off and then on;
wherein the predetermined condition indicates that the firmware of the BMC has been updated.

18. A computer configured to update a firmware therein, said computer comprising:
a motherboard;
a backplane being electrically connected to said motherboard;
a first complex programmable logic device (CPLD) being disposed on said motherboard, and having a register;
a second CPLD being disposed on said backplane and having a second-CPLD flash memory; and
a baseboard management controller (BMC) being disposed on said motherboard,
wherein said first CPLD is configured to be initiated after said computer is connected to a power source, and to change a logical value of a power-on reset signal when determining that a standby power of said computer is in a desired range,
said BMC is configured to receive the power-on reset signal, and to be initiated once the logical value of the power-on reset signal has been changed,
said BMC is further configured to, after a power-on button of said computer is being pressed, once determining that a central processing unit (CPU) of said computer is initiated, and that said BMC is to update a firmware of said second CPLD, change a logical value of a bit of said register, and
said first CPLD is further configured to, when determining that the logical value of the bit of said register has been changed, decode a firmware code that is received from said BMC, verify the firmware code thus decoded, and update the firmware code thus decoded and verified to said second-CPLD flash memory.

19. The computer as claimed in claim 18, further comprising a voltage stabilizer and a switch component that are disposed on said backplane, wherein
said switch component is electrically connected between said voltage stabilizer and said second CPLD,
said first CPLD is further configured to change the logical value of the bit of said register after updating the firmware code thus decoded and verified to said second-CPLD flash memory,
said BMC is further configured to, when determining that a change of the logical value of the bit of said register conforms with a predetermined condition indicating that the firmware of said second CPLD has been updated, send a restart signal to said switch component for controlling said switch component to switch from on to off and then to on again, thus switching a backplane power that is provided by said voltage stabilizer to said second CPLD through said switch component off and then on.

20. The computer as claimed in claim 18, further comprising a voltage stabilizer and a switch component that are disposed on said backplane, wherein
said switch component is electrically connected between said voltage stabilizer and said second CPLD,
said BMC is further configured to, when determining that a change of the logical value of the bit of the register conforms with a predetermined condition indicating that the firmware of the second CPLD has been updated, change a logical value of another bit of said register, and
said first CPLD is further configured to, when determining that the logical value of said another bit of said register has been changed, send a restart signal to said switch component for controlling said switch component to switch from on to off and then to on again, thus switching a backplane power that is provided by said voltage stabilizer to said second CPLD through said switch component off and then on.
